(19) United States
(12) Patent Application Publication
(10) Pub. No.: US 2011/0123960 A1
(43) Pub. Date: May 26, 2011

(54) SYSTEM FOR TRAINING AN OPERATOR OF A VESSEL

(75) Inventors: Thor Henning Amdahl, Hegra (NO); Baard E. Bjornsen, Stjordal (NO); Lars Einar Bjorseth, Jakobsli (NO); Helge Eilif Samuelsen, Trondheim (NO)

(73) Assignee: SHIP MANOEUVRING SIMULATOR CENTRE AS, Trondheim (NO)

(21) Appl. No.: 12/996,669

(22) PCT Filed: Jun. 8, 2009
(86) PCT No.: PCT/NO09/00211

§ 371 Date: Feb. 7, 2011

(30) Foreign Application Priority Data
Jun. 9, 2008 (NO) 20082671

(51) Int. Cl. G09B 9/02

(52) U.S. Cl. 434/29

(57) ABSTRACT

System and method for training aboard an actual vessel on manoeuvring the vessel in relation to one or more virtual movable and/or stationary objects, which vessel includes controllable propulsion means and is operated by an operator. The system includes a visualisation channel (11) which is arranged to provide a virtual world, which virtual world is continuously changed in relation to the position and movements of the actual vessel.

The invention relates to a system for training aboard an actual vessel on manoeuvring the vessel in relation to one or more virtual movable and/or stationary objects according to the preamble of claim 1. The invention also relates to a method for this according to the preamble of claim 10.

### BACKGROUND

It is known to train vessel operators and trainees by means of a simulator. It is, for example, known to practice on mastering approach and departure from port facilities, DP training and similar. Practice by means of simulators is also known from other areas, such as the operation of airplanes. It will be obvious to build simulation installations where a vessel operator or a trainee could practice on manoeuvring and maintaining, for example, a tanker near different installations. However, a good result of such training is dependent on a realistic experience of the simulator by the vessel operator. This requires in practice that the simulator includes an area which is equipped as a ship bridge, and where the vessel operator can experience realistic vessel motions. However, such simulators are expensive to build and run.

From US 2002052724 it is known to use an actual vehicle during simulation.

US 2003215771 describes an autonomous weapons system simulation system for use aboard and during flight.

JP 2004294686 describes a navigation simulator system for training of navigation, which system is arranged at the bridge of an actual ship.

EP 0399418 describes a system for mission-training which allows training of low-flying and other missions without flying near the ground.

There are no known solutions where a vessel can operate in a real world and at the same time in a virtual world for training of different operations. It is thus a need for providing a system which provides a realistic and more practical training of operators of a vessel, which system can be used aboard existing vessels and utilizes the existing vessel in connection with training.

### Object

The object of the invention is to provide a system for manoeuvring training for use aboard a vessel. It is further an object of the invention to provide a system where one can simulate different operations/exercises/tasks for training manoeuvring in relation to virtual installations/vessels by use of actual vessels. It is further an object of the invention that the virtual world/installations/vessels are affected by the actual conditions which the current actual vessel experiences. It is finally an object of the invention that the system should not interfere with the control devices or other devices of the vessel.

### The Invention

A system according to the invention is described in claim 1. Advantageous features of the system are described in claims 2-9. A method according to the invention is described in claim 10. Advantageous features of the method are described in claims 11-13.

By vessel is meant a self-powered motorized craft which has controllable propulsion means, preferably these are maritime vessels.

A system according to the invention includes a visualisation channel which preferably is formed by a control unit and a visualisation unit. The control unit is preferably a unit provided with a CPU and sufficient internal or external memory, such as a laptop or similar. The visualisation unit is preferably a monitor, which monitor can be controlled by the control unit, which monitor can be an external monitor or a monitor integrated in the control unit, such as the monitor of a laptop.

The system preferably further includes means for acquiring information on movements of the vessel from a reference system and information from the control means of the vessel, machinery, etc.

The system preferably also includes means for acquiring information on environmental conditions around the vessel which affect the vessel, such as wave height, wave direction, wind direction, etc.

The system preferably further includes logging means for logging, among others, movements of the vessel, the load of the control means of the vessel, position, etc.

The system further also includes communication means, which means can be used to download updates of software and to upload information to an external unit for further processing, such as the logged information.

The system is further preferably also provided with visual and/or audio means for visual and/or audible alarm.

The control unit of the system is further provided with means and/or software for providing a virtual world for actual vessels, further explained below. The control unit is further provided with predefined parameters (simulation parameters)/models/tasks which are to be used during training.

The control unit is provided, by means of the means for acquiring information, with information from the reference systems of the vessel, such as DP system, GPS, Gyro, MRU and similar, and preferably also information on environmental effect on the vessel, such as information from wind meters, wave radar or similar. The reference system does not need to be the vessel's own reference system, but can also be, for example, an external GPS, if it is only desirable to acquire information about the position.

The information is utilized by the control unit to create and display on the visualisation unit, a virtual world which is controlled by the actual position and movements of the vessel, and information on environmental effect. On basis of this information, the control unit by means of predefined parameters/models/tasks can create a virtual world for the actual vessel for training of manoeuvring. The virtual world shows a virtual model of the actual vessel and a virtual installation/object which the vessel is to be manoeuvred in relation to. The virtual world is continuously changed according to acquired information and according to the task/exercise being run.

The start position is set relative to the position of the vessel when an exercise/task starts.

The control unit is, as mentioned, provided with predefined exercises/tasks, for example, manoeuvring training in relation to a platform, tension leg or floating platform. Each of these platform types has different challenges as regards manoeuvring, and this will be simulated. Floating platforms can start to move unintentionally in the platform systems, and the operator should be trained to handle such incidents.

No changes of the control systems or reference systems of the vessel are necessary for using the system.

The system according to the invention does neither intervene with the control systems nor reference systems of the vessel, and the system is only connected for acquiring information and for power supply.

The system may also include a communication module which communicates with a communication module of another movable or stationary object, so that two or more vessels/objects/installations can practice in the same visualised model, for example, the same operation and in addition have to take each other into consideration, e.g. AIS communication can be implemented.

As manoeuvring training is to be performed, the vessel positions in a position where it does not constitute a danger to installations or other activity.

By means of the system according to the invention, a predefined exercise/task is started, and the visualisation unit shows the actual vessel as a virtual model in a virtual world, and the operator can thus practise on manoeuvring in relation to a virtual installation defined by the system according to the invention. The operator can thus perform operations (tasks) as if they lie, for example, near a platform, while they actually find oneself at a completely different location, preferably at open sea.

The exercises are performed in real time, and the vessel with machinery, rudders, thrusters, gyros, GPS, DP system and possibly reference systems are operated as normal. The vessel is affected by wind and current as under normal operations. Other personnel must perform their tasks as if they were under normal work. This can be done anywhere, as long as one has a large space around oneself, and signal from the reference systems used. The virtual world which is shown on the visualisation unit will continuously be updated in relation to the current exercise/task and in relation to the actual movements of the vessel, and the vessel thus becomes a realistic simulator.

By means of the logging means of the system, relevant information is logged, such as load of the control means of the vessel, position, etc., so that the exercise can be examined later by qualified personnel to determine if an exercise was performed according to the desired result. It would of course be of special interest if the vessel has been too close to the virtual installation and if dangerous situations have occurred.

The logged results are preferably transferred to qualified personnel as the vessel is online.

Thus, by means of the system, an operator may practice safely on difficult operations while the vessel is far away from possible obstacles.

The operator is thus provided with live training of different operations with the vessel they shall use in their everyday work after the exercise, and at the same time they do not have to leave the vessel to achieve sea experience in connection with manoeuvring training.

The vessel can thus use free time to practice on difficult operations, which results in reduced risk for undesired incidents during difficult operations.

The system according to the invention will be appreciated by, among others, the oil companies for reducing unexpected incidents by unqualified personnel, and for shipping companies which today lack own training for supply vessels and similar, and training of personnel of these types of vessels.

Further advantages and preferable features of the invention will appear from the following example description.

### EXAMPLE

The invention will be described below in detail with reference to the attached Figures, where:

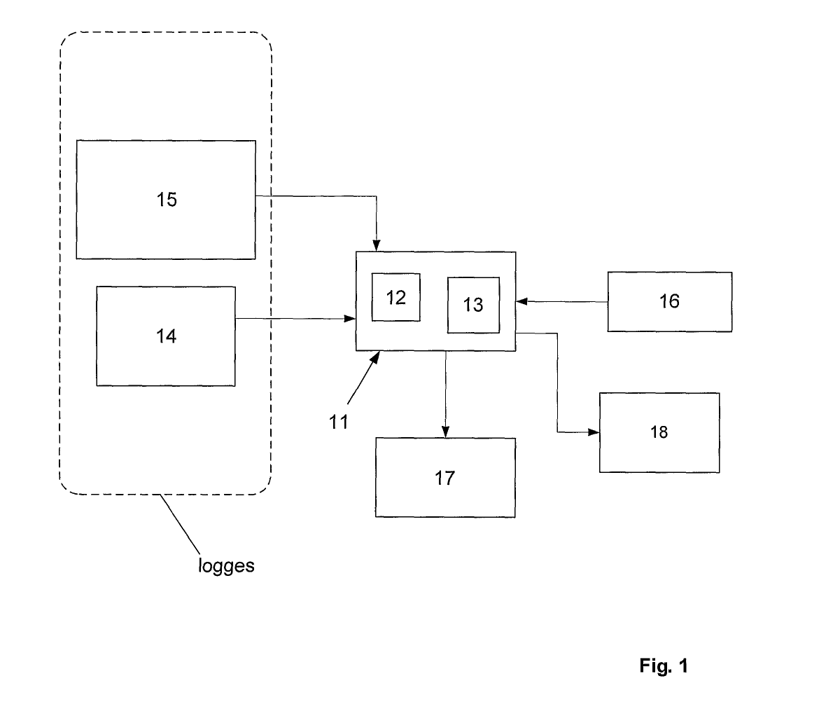

FIG. 1 is a principle drawing of a system according to the invention,

FIG. 2 shows a view of how the system is adapted on a vessel, and

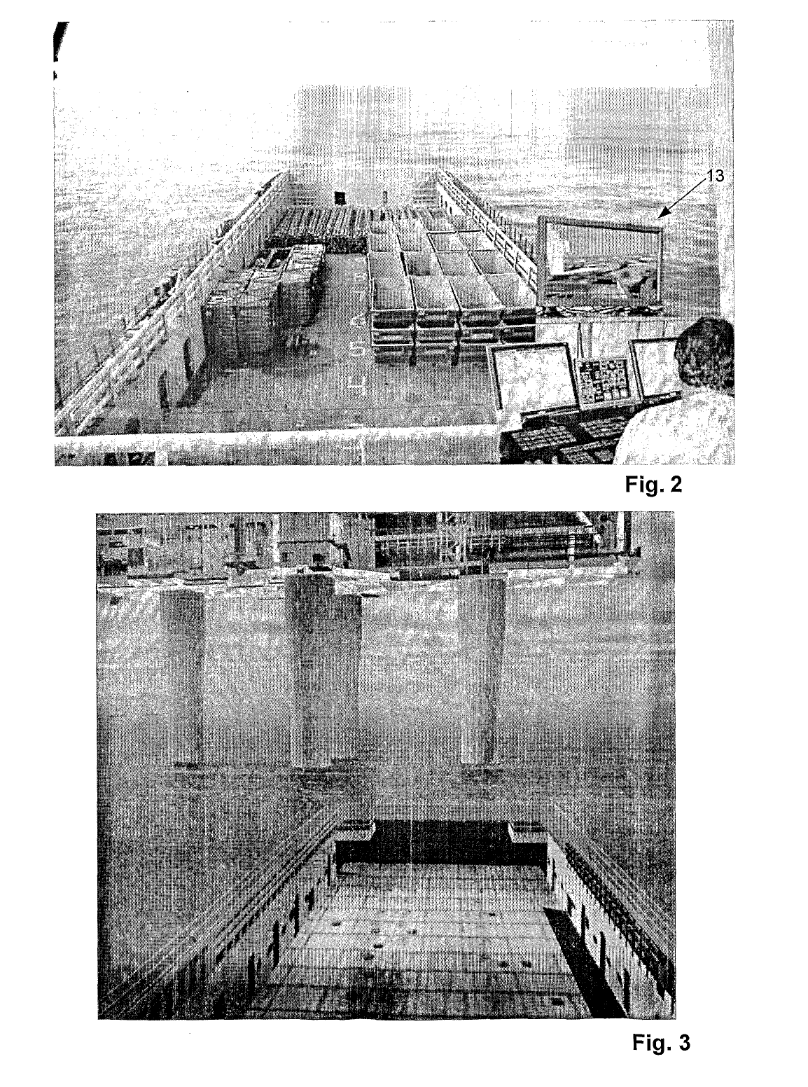

FIG. 3 shows an enlarged view of an interface from a visualisation unit.

Reference is now made to FIG. 1 which shows a principle drawing of a system according to the invention. A system according to the invention is adapted for arrangement to a vessel having controllable propulsion means and which is operated by an operator, preferably a marine vessel.

A system according to the invention includes a visualisation channel 11 which preferably is formed by a control unit 12 and a visualisation unit 13. The control unit 12 is preferably a unit which is provided with a CPU and sufficient internal or external memory, e.g. a laptop. The visualisation unit 13 is preferably a monitor which is controlled by the control unit 12, such as a computer monitor or other suitable external or integrated monitors, e.g. is the visualisation unit 13 integrated in the control unit 12, e.g. in the form of a laptop.

The system further includes means for acquiring information on the movements of the vessel from a reference system 14 and information from the control means 15 of the vessel. The reference system 14 is preferably at least a system which provides information of the position of the vessel, such as a GPS, but also such as, for example, a DP system, Gyro, MRU or similar can be used to provide information of the movements of the vessel, which can be utilized by the control unit 12.

The system includes preferably also means 16 for acquiring information on environmental conditions affecting the vessel, such as wave height, wave direction, wind direction, etc., by means of, for example, wind meters, wave radar or similar.

The system preferably includes logging means 17 for logging information related to the performance of an exercise/task, such as the position/movements of the vessel, the load of the control means of the vessel and other information of interest for evaluation by qualified personnel of an exercise/task.

The system further includes communication means 18, which means can be used for downloading updates of software, settings, parameters, etc., and to upload information to an external unit for further processing, such as the logged information for evaluation/reconstruction of an exercise/task.

Preferably, the system can further be provided with visual and/or audible means (not shown) for visual and/or audible alarm. For example, the visualisation unit 13, i.e. e.g. the monitor of a laptop, can be used to provide a visual alarm, while an audible alarm, for example, can be sounded via a speaker arranged to or integrated in the laptop.

The control unit 12 of the system, i.e. e.g. the CPU of a laptop and internal and/or external memory, is provided with means and/or software for providing a virtual world for actual vessels, which virtual world is presented on the visualisation unit 13. The control unit is further provided with predefined parameters (simulation parameters), models, tasks, exercises or similar, which are to be used during training. This includes, among others, virtual installations which are to be presented and which exercises/tasks which are to be performed in relation to these virtual installations. This includes further virtual models of the actual vessel which also is to be presented in relation to another virtual movable or stationary object, such as a virtual ROV, virtual platform, another virtual vessel, and virtual harbour or similar.

The control unit 12 is, by means of the means for acquiring information, provided with information from reference systems 14 of the vessel, such as a DP system, GPS, Gyro, MRU or similar, and preferably also information on environmental effect on the vessel from suitable means 16, such as a wind meter, wave radar or similar.

The control unit 12 is further provided with information from the control means 15 of the vessel, such as information on the load of machinery, rudders, thrusters and similar. The information is then used by the control unit 12 to create and present on the visualisation unit 13, a virtual world which is controlled by the actual position and movements of the vessel, and information on environmental effect. On basis of this information, the control unit 12 can, by means of the predefined parameters (simulation parameters), models, tasks, exercises, etc., create a virtual world for the actual vessel for training of manoeuvring in relation to virtual movable and/or stationary objects. The virtual world shows a virtual model of the actual vessel and one or more virtual objects which the actual vessel, via the virtual model, is to be manoeuvred in relation to. During an exercise/task, the virtual world is continuously updated according to information supplied to the system, especially from the reference systems of the vessel.

By means of the system, an operator can manoeuvre the vessel by means of its propulsion means so that the virtual model of the actual vessel performs the desired operations/manoeuvrings in relation to the virtual movable and/or stationary object(s).

The start position in the virtual world is set relative to the position of the vessel as an exercise/task starts.

The control unit is, as mentioned, provided with predefined exercises/tasks, for example, manoeuvring training in relation to a platform, tension leg or floating platform, or other conceivable movable and/or stationary objects. Each of these installations has different challenges as regards manoeuvring, and this can be simulated by means of the system. Floating platforms can start to move at error in the platform systems, and the operator should be trained to handle such incidents. The different exercises/tasks can of course include unexpected situations which the operator must consider, which unexpected incidents are predefined in the exercise/task.

An important feature of the system is that it is not necessary to perform any changes to the control systems of the vessel in order to use the system. The system neither intervenes in the control systems nor reference systems of the vessel, but only acquires information which is utilized during use.

The system can also include a communication module which communicates with a communication module of another vessel, so that two or more vessels can practice in the same visualised world, e.g. the same operation/exercise/task, and in addition they must consider each other, e.g. can AIS communication be implemented. The vessels are of course positioned with a large distance from each other, so that there is no risk for dangerous situations to arise.

When an exercise/task for manoeuvring training is to be performed, the vessel positions itself in a position where it does not constitute any danger for installations or other activity. An exercise/task is chosen and run. During the exercise/task, all relevant information of interest is stored/logged by the logging means 17 for evaluation/reconstruction by qualified personnel, preferably later. The system is of course arranged so that exercises/tasks can be aborted and started again. After an exercise/task is completed, the relevant information is prepared for sending to an external unit via the communication means 18, as the vessel is connected to a network or is online. The information can be examined by suitable personnel for further processing, such as evaluation, reconstruction and approval of performed exercises/tasks.

Reference is now made to FIG. 2 which shows a visualisation unit 13, arranged at the bridge of a vessel. The Figure shows that when an operator looks out the window of the bridge, he/she only sees open sea, but when the operator looks at the visualisation unit 13, he/she sees how the vessel is moving in relation to a virtual object, in a virtual world in an exercise/task, where the actual vessel is represented via a virtual model. An enlarged view of a situation in the virtual world which is shown on the visualisation unit 13 is shown in FIG. 3, where a vessel is manoeuvred in relation to a platform during an exercise/task.

### Modifications

The system can also be arranged for communication with, for example, the engine room of a vessel, so that, for example, controlled motor failure, failure of thrusters or similar can be arranged during an exercise. This is preferably performed by qualified personnel in the engine room.

This makes it possible to practice on critical error conditions which can arise in connection with motor failure or similar.

Even if the system herein is described in connection with maritime installations/objects, the system can also be used for manoeuvring in connection with docking, guiding of vessels in rivers, lifting operations, subsea operations, diving, pipe laying, digging, etc.

The system can also have other areas of use, such as training of parallel parking of cars, backing of camping trailers or similar.

This shows that there are many possibilities for a system according to the invention, but the main task of the described system is related to maritime vessels and maritime environments.

Further, the system can be provided with online sending of logged information, so that qualified personnel, for example, can monitor an exercise/task in approximately real time.

1. System for training aboard an actual vessel on manoeuvring the vessel in relation to one or more virtual movable and/or stationary objects, which vessel includes controllable propulsion means and is operated by an operator, which system includes a visualisation channel (11) which includes a control unit (12) and a visualisation unit (13), characterized in that the system also includes means for acquiring information on exterior environmental effect on the vessel from suitable means (16), such as wind meters, wave radar or similar, where the visualisation channel (11) is arranged to provide a virtual world, which virtual world is continuously changed in relation to the position and movements of the actual vessel, and information on the exterior environmental effect on the vessel.

2. System according to claim 1, characterized in that the system further includes means for acquiring information on the movements of the vessel from a reference system (14) and/or control means (15) of the vessel.

3. System according to claim 1, characterized in that the system includes a communication module for communication with a communication module on another actual object/vessel.

4. System according any claim 1, characterized in that the system further includes logging means (17) for logging relevant information, including movements of the vessel, load of the control means of the vessel, positions, velocities, directions, environmental variables, such as wind, waves, current or similar from the vessel which is manoeuvred, possible exercise related information, and information from another vessel.

5. System according claim 1, characterized in that the system further includes communication means (18) for communication with an external unit, preferably for transferring logged information for evaluation.

6. System according to claim 1, characterized in that the system further includes visual means and/or audible means for visual and/or audible alarm.

7. System according to claim 2, characterized in that the control unit (12) includes external or internal memory.

8. System according claim 1, characterized in that the control unit (12) is provided with predefined exercises/tasks and/or other predefined simulation parameters to create/change the virtual world.

9. System according claim 1, characterized in that the control unit (12) is provided with means and/or software for creating a virtual world, which virtual world is shown on the visualisation unit (13).

10. Method for training aboard an actual vessel on manoeuvring the vessel in relation to one or more virtual movable and/or stationary objects, which vessel includes controllable propulsion means and is operated by an operator, and is provided with a system for training aboard including a visualisation channel, which includes a control unit and a visualisation unit, characterized in that the method includes the following steps:
a) loading a predefined exercise/task and predefined parameters,
b) creating a virtual world which represents a virtual model of the real vessel and virtual movable and/or stationary objects,
c) acquiring information from reference systems and control systems of the vessel, and acquiring information on environmental conditions affecting the vessel,
d) updating the virtual world,
e) continuously repeating the steps c)-d) until the exercise/task is completed.

11. Method according claim 10, characterized in that step c) also includes communication with another actual object/vessel to acquire information on the position and movements of the other object/vessel.

12. Method according claim 10, characterized in that the method further includes providing a visual and/or audible alarm if predefined limits are exceeded.

13. Method according claim 10, characterized in that the method further includes logging of all relevant information, including movements of the vessel, load of the control means of the vessel, positions, velocities, directions, environmental variables, such as wind, waves, current or similar from the vessel which is manoeuvred, possible exercise related information, and information from another vessel.
